(19) United States
(12) Patent Application Publication
(10) Pub. No.: US 2024/0183523 A1
(43) Pub. Date: Jun. 6, 2024

(54) ENHANCED THERMAL DESIGN FOR HIGH POWER LIGHTING FIXTURE

(71) Applicant: Multi Faith Limited, HONG kONG (CN)

(72) Inventors: Laurent Rene Raymond COLLOT, Hong Kong (CN); KAVEESH SIVARAJ, HONG KONG (CN)

(73) Assignee: Multi Faith Limited, HONG KONG (CN)

(21) Appl. No.: 18/074,443

(22) Filed: Dec. 2, 2022

(51) Int. Cl. F21V 29/76; F21V 29/503; F21V 29/51

(52) U.S. Cl. CPC F21V 29/76; F21V 29/503; F21V 29/51

(57) ABSTRACT

Aspects of the invention improve existing approaches by providing an enhanced thermal design for high power lighting fixture. In one embodiment, the thermal design enables the high power lighting fixture, such as light emitting diode (LED) lighting devices to perform for extended periods. In a further embodiment, the thermal design includes a vertical dual fin design. In one embodiment, the design may exhibit a “V” shaped design. In a further aspect, the thermal design includes a plurality of thermal fins on external facing surfaces of the thermal design. The thermal design, in a further embodiment, may include vapor chambers on inward facing surfaces of the “V” shaped designs. Further, an end portion of the thermal design may be connected to the lighting fixture so as to dissipate heat for the lighting fixture.

### FIELD OF THE INVENTION

Aspects of the invention generally relate to lighting fixture designs. More specifically, embodiments of the invention relate to improved document creation.

### BACKGROUND

Horticulture technology has involved over the years when consumers' food consumption habits are changing. The health benefits of consumption of vegetables have in focus in recent years, and the businesses are creating different ways to increase yield.

Despite different areas of focus within the science of horticulture, such as olericulture, pomology or fruticulture, floriculture, or the like, most of the focus is on using existing technologies, such as a lighting system, and a sprinkler irrigation system. Further communication or network devices used therein are often off-the-shelf purchase, so the management of the overall system has various shortcomings.

Further, existing lighting fixtures are ill-equipped to handle high power outputs.

### SUMMARY OF THE INVENTION

Aspects of the invention improve existing approaches by providing an enhanced thermal design for high power lighting fixture. In one embodiment, the thermal design enables the high power lighting fixture, such as light emitting diode (LED) lighting devices to perform for extended periods. In a further embodiment, the thermal design includes a vertical dual fin design. In one embodiment, the design may exhibit a “V” shaped design. In a further aspect, the thermal design includes a plurality of thermal fins on external facing surfaces of the thermal design. The thermal design, in a further embodiment, may include vapor chambers on inward facing surfaces of the “V” shaped designs. Further, an end portion of the thermal design may be connected to the lighting fixture so as to dissipate heat for the lighting fixture.

### BRIEF DESCRIPTION OF THE DRAWINGS

Persons of ordinary skill in the art may appreciate that elements in the figures are illustrated for simplicity and clarity so not all connections and options have been shown. For example, common but well-understood elements that are useful or necessary in a commercially feasible embodiment may often not be depicted in order to facilitate a less obstructed view of these various embodiments of the present disclosure. It may be further appreciated that certain actions and/or steps may be described or depicted in a particular order of occurrence while those skilled in the art may understand that such specificity with respect to sequence is not actually required. It may also be understood that the terms and expressions used herein may be defined with respect to their corresponding respective areas of inquiry and study except where specific meanings have otherwise been set forth herein.

FIG. 1 is a diagram illustrating a thermal design for a lighting fixture according to one embodiment.

FIGS. 2-4 illustrate thermal readings of a thermal design according to one embodiment.

### DETAILED DESCRIPTION

Embodiments may now be described more fully with reference to the accompanying drawings, which form a part hereof, and which show, by way of illustration, specific exemplary embodiments which may be practiced. These illustrations and exemplary embodiments may be presented with the understanding that the present disclosure is an exemplification of the principles of one or more embodiments and may not be intended to limit any one of the embodiments illustrated. Embodiments may be embodied in many different forms and should not be construed as limited to the embodiments set forth herein; rather, these embodiments are provided so that this disclosure may be thorough and complete, and may fully convey the scope of embodiments to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description may, therefore, not to be taken in a limiting sense.

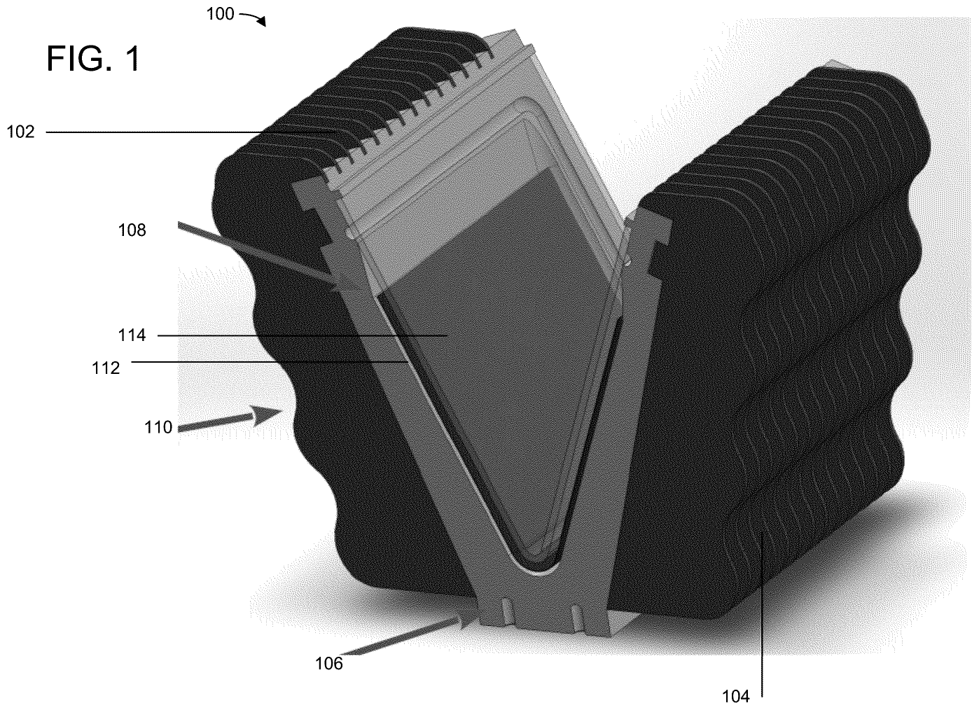

Referring now to FIG. 1, a block diagram illustrates a thermal design 100 for a lighting fixture according to one embodiment. In one embodiment, the design 100 may be include two wings 102 and 104, and a base 106. In one embodiment, the design 100 may have only one wing, such as 102 or 104 and the base 106. In one aspect, the wings 102 and 104 are joined at the base 106. In one aspect, the base 106 may have a width fitting or accommodating a lighting fixture (not shown).

Still referring to FIG. 1, the design 100 may include a body 108 for supporting the wings 102 and 104. In one aspect, the body 108 may have an outward facing surface and the surface comprises one or more thermal fins 110 for assisting dissipation of heat. In another embodiment, the body 108 may include an inward facing surface 112. In one aspect, the inward facing surface 112 may include a vapor chamber 114. In one example, the vapor chamber 114 may include a fiber-glass and grooves so that to efficiently transfer heat generated by the lighting fixture to the thermal fins 110.

In one example, the body 108 and the thermal fins 110 may be made of cast aluminum to provide optimal heat dissipation properties as well as light weight. In another aspect, the thermal fins 110 may be disposed or positioned vertically, such as shown in FIG. 1. For example, the body 108 may be in a “V” shape and the fins 110 are extending outwardly from the outward facing surface. In vertical design, with respect to the position of the light fixture, may provide or offer the best possible exchange with the air flow. In one aspect, the length of each fin in the fins 110 may depend on a variety of factors, such as weight and the cost. It is to be understood that various length of the fins may be consider without departing from the scope or spirit of the invention. For example, the length of the fins 100 may need not to be uniform.

In a further aspect, the lighting fixture is disposed at the base 106 to limit or minimize the shadow of the lighting fixture when the natural light is available. In other words, current lighting fixture designs include a wide covering or housing for various reasons, such as housing power supplies, rigidity and other reasons. However, due to the sizes, these housings block the natural light and therefore create unnecessary shadow. The present thermal design 100 attempt to reduce, lessen or alleviate the overall surface area so as to avoid the area of the shadow while achieving all the advantages or benefits as indicated above.

Further the reduction of the heat or temperature of the lighting fixture may increase the quantum efficiency of the lighting fixture and maximize their lifetime.

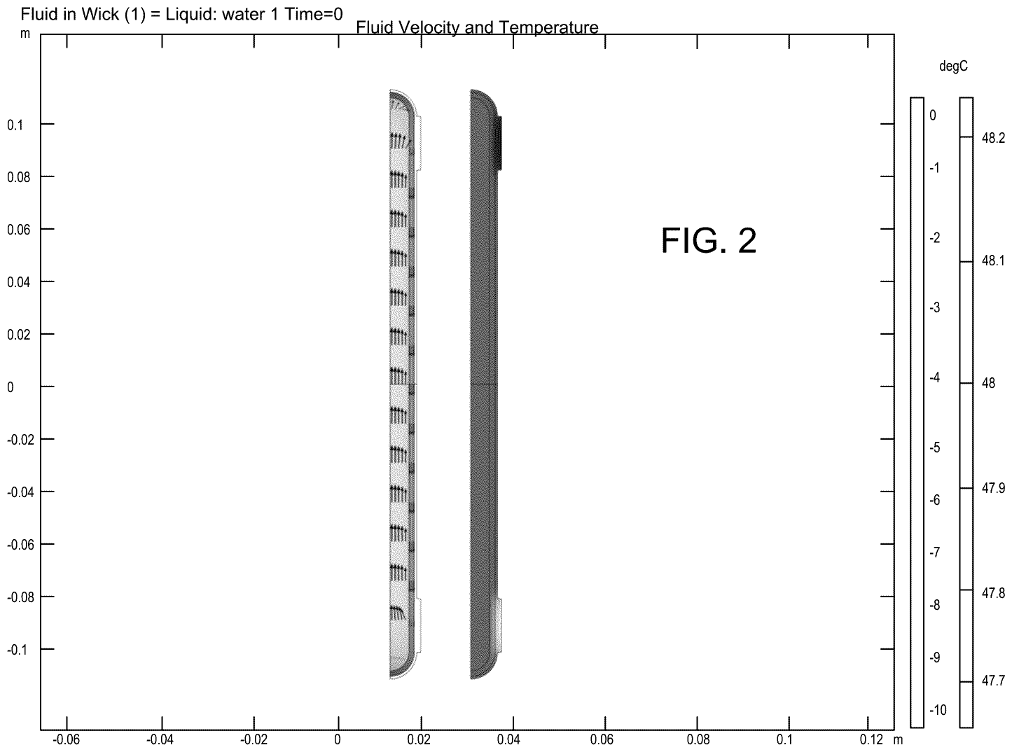

Referring now to FIGS. 2-4, one or more thermal study or reading of the thermal design 100. For example, FIG. 2 illustrates a heat graph showing a simulation of the full physics of the working fluid cycling through the thermal design 100. For example, liquid boils from the bottom with vapor flowing to the condenser part. Thereafter, the vapor condenses and returns to the bottom flowing through the wick or the vapor chamber.

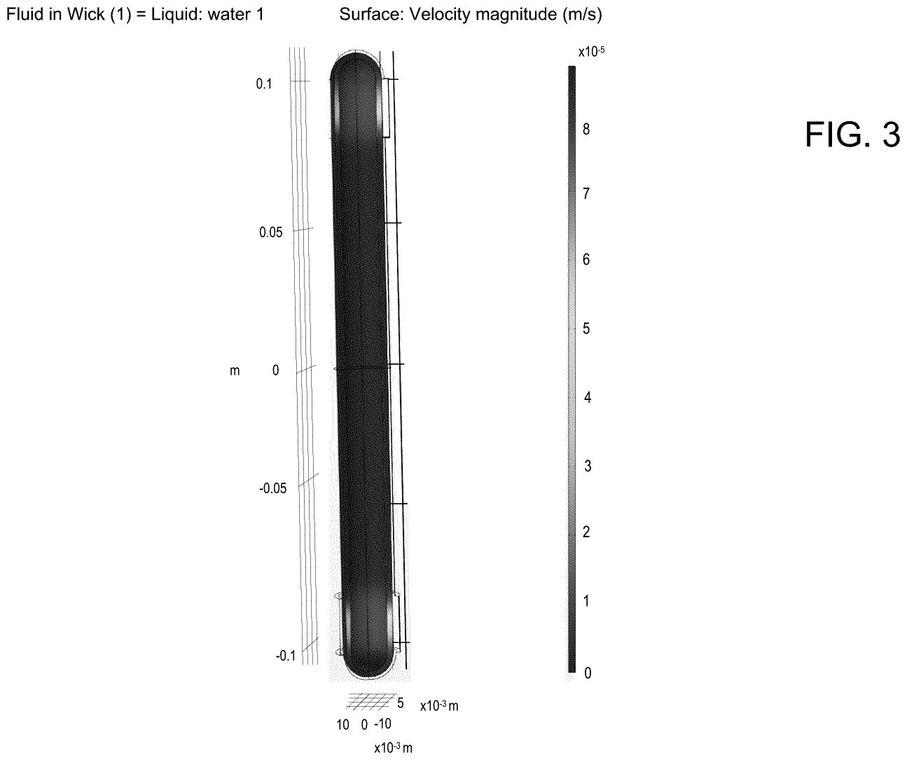

FIG. 3 then illustrates a temperature diagram showing working fluid motion. For example, the liquid flow through the wick or the vapor chamber at about 0.1 mm/s. However, considering the latent vaporization heat of water in the present invention, large flow rate may be achieved, such as kilowatt per centimeter of the vapor chamber.

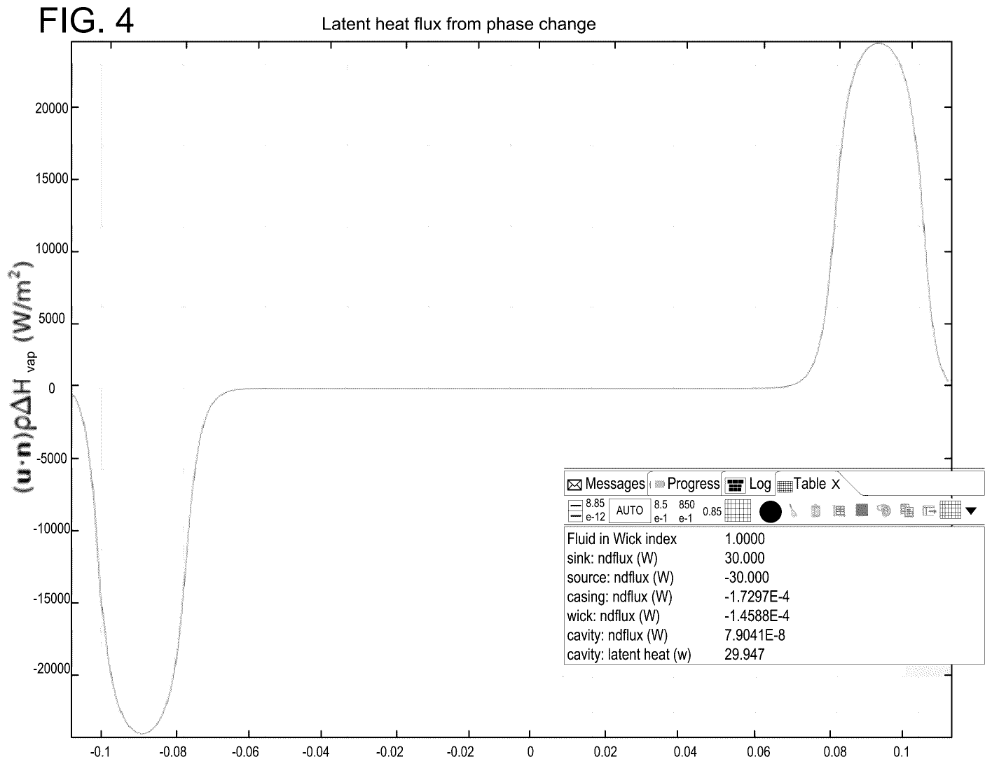

Referring to FIG. 4, a graph showing that for about 20 W/cm of the light fixture, the delta-T is negligible. As such, aspects of the invention provide great potential for the capabilities of the invention.

In another embodiment, the vapor chamber may include a wick or wicking material. In one example, the wick may be made of fine stainless steel mesh.

It may be understood that the present invention as described above may be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of embodiments may become apparent to those skilled in the art upon review of the disclosure. The scope embodiments should, therefore, be determined not with reference to the above description, but instead should be determined with reference to the pending claims along with their full scope or equivalents.

One or more features from any embodiment may be combined with one or more features of any other embodiment without departing from the scope embodiments. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it may be understood by those of ordinary skill in the art having the present specification, figures and claims before them, that the corresponding structure includes a computer, processor, or microprocessor (as the case may be) programmed to perform the particularly recited function using functionality found in a computer after special programming and/or by implementing one or more algorithms to achieve the recited functionality as recited in the claims or steps described above. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one embodiments to the embodiments illustrated.

The present disclosure provides a solution to the long-felt need described above. In particular, aspects of the invention provide an enhanced thermal design to dissipate heat generated from the lighting fixture attached thereto while minimizing shadow created by the casing of the lighting fixture.

Further advantages and modifications of the above described system and method may readily occur to those skilled in the art.

The disclosure, in its broader aspects, is therefore not limited to the specific details, representative system and methods, and illustrative examples shown and described above. Various modifications and variations may be made to the above specification without departing from the scope or spirit of the present disclosure, and it is intended that the present disclosure covers all such modifications and variations provided they come within the scope of the following claims and their equivalents.

What is claimed is:

1. A thermal apparatus for a lighting fixture comprising:
a body for supporting two wings;
wherein each of the two wings comprises an outward facing surface comprising one or more thermal fins;
wherein each of the two wings comprises an inward facing surface comprising a vapor chamber;
a base for joining the body one side and for joining the lighting fixture on another side of the base; and
wherein the thermal fins and the vapor chamber are arranged to dissipate heat produced by the lighting fixture.

2. The thermal apparatus of claim 1, wherein the body and the base are made of cast aluminum.

3. The thermal apparatus of claim 1, further comprising a wick disposed in the vapor chamber.

4. The thermal apparatus of claim 3, wherein the wick is made of stainless steel mesh.
